(19) United States
(12) Patent Application Publication
(10) Pub. No.: US 2017/0017709 A1
(43) Pub. Date: Jan. 19, 2017

(54) MULTIPLE VIRTUAL DATA MODEL DEPLOYMENT

(71) Applicant: SAP SE, Walldorf (DE)

(72) Inventor: Siar Sarferaz, Heidelberg (DE)

(21) Appl. No.: 14/799,502

(22) Filed: Jul. 14, 2015

(51) Int. Cl. G06F 17/30

(52) U.S. Cl. CPC G06F 17/30575

(57) ABSTRACT

According to an embodiment of the present disclosures, systems, methods, and non-transitory computer-readable mediums having program instructions thereon, provide for replicating core data service (“CDS”) views from different source systems at a central server. Meta-data corresponding to the desired database application tables are replicated at each of the source systems and are utilized to generate the CDS views at the central server. Further, any changes to CDS views at the respective source systems are tracked and automatically replicated at the central server.

### FIELD

The present disclosure relates generally to the deployment of CDS views from different source systems to a central server.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an embodiment of the conventional architecture utilized in cross-system analytics.

FIG. 2 illustrates an embodiment of the architecture utilized in the present disclosure.

FIG. 3 illustrates an embodiment of Data Dictionary tables containing the meta-data.

FIG. 4 illustrates another embodiment of the architecture utilized in the present disclosure.

FIG. 5 illustrates an embodiment of the interaction between the elements of the architecture utilized in the present disclosure.

### DETAILED DESCRIPTION

According to an embodiment of the present disclosures, systems, methods, and non-transitory computer-readable mediums having program instructions thereon, provide for deploying CDS views from different source systems to a central server.

Cross-system analytics refers to the consolidation, transformation and cleansing of data from different data sources. Specifically, a harmonized and consistent view of data from different data sources is provided for the reporting (and analyzing) of the data within a company at an application server. However, when data is exchanged among several, different source systems, it is very likely that the data from the different source systems will be incompatible in a business or technical context. For example, with regard to cost centers (i.e., a type of master data), the same cost center key can exist in multiple source systems with different cost centers applied. Accordingly, when data is exchanged across different source systems, functionality is needed to combine the different data sets and create a common data foundation. Further, data consistency must also be ensured. For example, different releases of source systems must be managed, replication dependencies (e.g., master-detail) have to be considered and separation of data from different source systems has to be supported. Moreover, it is also necessary to monitor the logic and flow of data exchanged from various systems, including applications from different enterprise systems (e.g., SAP S/4 HANA®, Oracle Enterprise Manager®, etc.). However, in cross-system analytics, core data models very often need to be defined numerous times (i.e., in order to add minor meta-data to the core data model) for different purposes. For example, technology solutions corresponding to integration, user interface (“UI”), analytics and transactions require their own data models. Accordingly, the time, cost and development (“TCD”) of providing the data from the different source systems increases as the same content must be provided several times. In addition, for incompatible meta-data models from different source systems, cross-system issues like UI integration, extensibility or authorization, have to be addressed and solved several times. This results in a higher time, cost and operation (“TCO”) of providing the data from the different source systems.

As such, to address the above concerns, one core data model is defined for the meta-data of the different source systems. Specifically, core data services (CDS) are utilized to implement the core data model (e.g., virtual data model). Core data services are a common set of domain-specific languages (DSL) and services for defining and consuming semantically rich data models. The virtual data models govern how CDS views are created through a set of rules, i.e., specific naming conventions, specific modeling rules, etc. The CDS views hide the cryptic database models of the database tables and provide a reusable, semantic layer which can be consumed in different scenarios, e.g., analytics, planning, search or transactional. The CDS views defined over the database application tables can be used to model a specific data object (e.g., sales order) which can later be consumed, at runtime, via an analytics engine (e.g., SAP® BW Analytical Engine) included with the application server (e.g., SAP S/4 HANA®—AS ABAP). The CDS views are defined with Structured Query Language (“SQL”). Further, included with the SQL statement defining the CDS view is meta-data information describing each attribute of the data object (e.g., meta-data corresponding to: (i) how to display the data in the UI, (ii) how to aggregate data, etc.). The analytics engine evaluates the meta-data of the CDS views, e.g., analytical annotations, in order to enable the analytic functionality (e.g., hierarchy handling). Accordingly, redundant data modeling is avoided and the above-mentioned cross-system issues are solved for uniformly.

However, because current solutions require that users manually define and build each CDS view used to interpret the database application tables, as the number of sources systems (and therefore data volume) increases, so will the time, cost, development and operation required to maintain the CDS views. Further, even if the CDS views are already defined and deployed at the application server, if there are any enhancements or updates to the CDS at the respective source systems, the CDS views still have to be redefined at the application server. In other words, current solutions do not provide a means for efficiently generating the CDS views or updating the CDS views at the application server in response to changes (e.g., new releases, updates or enhancements) to the CDS views at each of the respective source system.

In an embodiment, the present disclosure is directed to systems and methods for replicating the CDS views from each of the respective source systems at the application server. Specifically, meta-data corresponding to the desired database application tables are replicated at each of the source systems and are utilized to generate the CDS views at the application server. Further, in an embodiment, any changes to CDS views at the respective source systems are tracked and automatically replicated at the application server.

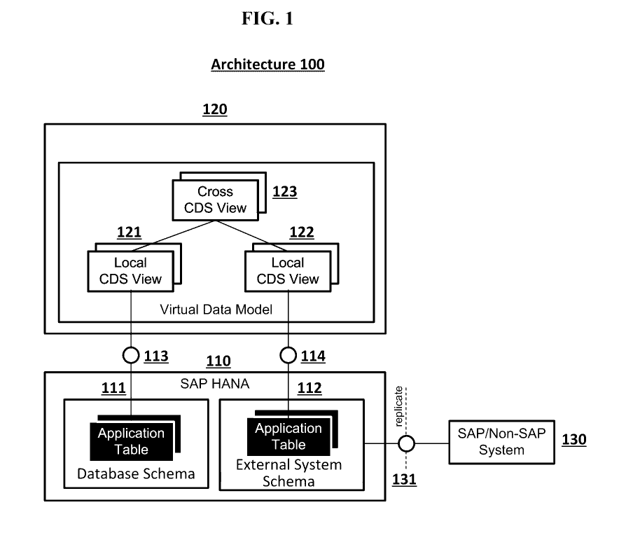

FIG. 1 illustrates an embodiment of the conventional architecture utilized in cross-system analytics. In an embodiment, architecture 100 of FIG. 1 includes a database 110, application server 120, source systems 130, replication node 131 and consumption nodes 113 and 114. In an embodiment, a UI (not shown) is applied on top of the application server 120. In an embodiment, database 110 is an in-memory database system. In an embodiment, the application server 120 includes local CDS views 121 and 122 and cross CDS views 123. In an embodiment, each of the local CDS views 121 and 122 include stacks of CDS views corresponding to different application tables in the database 110. For example, the local CDS views 121 correspond to application tables originally associated with the database 110 (e.g., SAP S/4 HANA®) and the local CDS views 122 correspond to application tables in database 110 that are originally associated with an external source (e.g., Oracle Enterprise Manager®). In an embodiment, cross CDS views 123 are a combination of each of the local CDS views 121 and 122. In an embodiment, each of the local CDS views 121 and 122 can correspond to specific data objects (e.g., sales order) associated with certain application tables in database 110. Further, local CDS views 121 and 122 and cross CDS view 123 can be consumed, at runtime, via an analytics engine (not shown). In an embodiment, during operation of a cross-system analytics application, data is initially replicated from source systems 130 via a replication node 131. In an embodiment, the data replicated from source systems 130 can be native to the schema utilized in database 110 or can be from an external system. Accordingly, data from source systems 130 is separated into database schema 111 and external system schema 112. Once the data from the source systems 130 is replicated, application database tables 111 and 112 are consumed via consumption nodes 113 and 114, respectively, in order to define local CDS views 121 and 122 on top of the application database tables. Further, cross CDS views 123 are also defined on top of the local CDS views 121 and 122 for future implementation of cross-system analytics scenarios. Further, in an embodiment, the transactional processes are also implemented in the application server 120. As stated previously, however, as the number of sources systems (and therefore data volume) increases, so will the time, cost, development and operation required to maintain the CDS views.

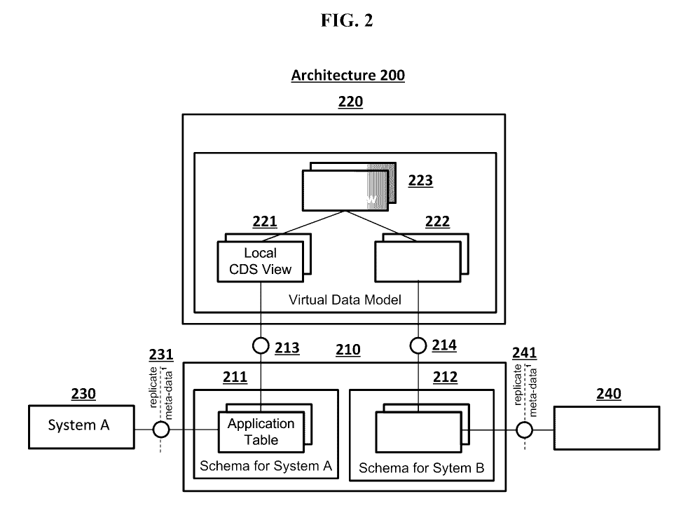

FIG. 2 illustrates an embodiment of the architecture utilized in the present disclosure. In an embodiment, architecture 200 of FIG. 2 includes a database 210, a central server 220, source system A 230, source system B 240, replication nodes 231 (i.e., corresponding to System A) and 241 (i.e., corresponding to System B) and consumption nodes 213 (i.e., corresponding to System A) and 214 (i.e., corresponding to System B). In an embodiment, database 210 is an in-memory database system. In an embodiment, the central server 220 includes local CDS views 221 and 222 and cross CDS views 223. In an embodiment, each of the local CDS views 221 and 222 include stacks of CDS views corresponding to different application tables in the database 210. For example, the local CDS views 221 correspond to application tables originally associated with source system A 230 and the local CDS views 222 correspond to application tables in database 210 that are originally associated with source system B 240. In an embodiment, cross CDS views 223 are a combination of each of the local CDS views 221 and 222. In an embodiment, source systems 230 and 240 correspond to the same virtual data model. In other words, the CDS views for the data associated with source systems 230 and 240 are governed by the same set of rules (i.e., specific naming conventions, specific modeling rules, etc.). In an embodiment, each of the local CDS views 221 and 222 can correspond to specific data objects (e.g., sales order) associated with certain application tables in database 210. Further, local CDS views 221 and 222 and cross CDS view 223 can be consumed, at runtime, via an analytics engine (not shown). Further, in another embodiment, unlike application server 120, transactional processes are not implemented in the central server 220.

In an embodiment, during operation of a cross-system analytics application, meta-data is initially replicated from source systems 230 and 240 via replication nodes 231 and 241. Accordingly, in contrast to FIG. 1, as opposed to replicating the data from the source systems, meta-data is being replicated. Meta-data information is usually stored in the Data Dictionary tables of the source systems 230 and 240. Meta-data definitions are created and managed in the Data Dictionary. The Data Dictionary permits a central description of all the data used in the system without redundancies. Further, new or modified information is automatically provided for all the system components. Corresponding objects like tables or views can be created in the underlying relational database system using these meta-data definitions. The Data Dictionary therefore describes the logical structure of the objects used in application development and shows how they are mapped to the underlying relational database system in tables or views. Tables are defined in the Data Dictionary independently of the database system. Further, a table having the same structure is then created from this table definition in the underlying database system. Further, views are logical views on more than one table. The structure of the view is defined in the Data Dictionary. A view on the database system can then be created from this structure. Data element describes the meaning of the contents of a table field. The fields of same semantic can refer to the same data element containing the field information. Different fields having the same technical type can be combined in domains. A domain defines the value range of all table fields and structure components that refer to this domain. Accordingly, by replicating the meta-data tables for views, tables, data elements & domains stored in the Data Dictionary tables, the CDS views for the data from Systems A and B can be automatically generated in the central server. Thus, local CDS views 221 and 222 do not need to be defined and built manually. However, cross CDS views 223 still need to be defined on top of the local CDS views 221 and 222 for future implementation of cross-system analytics scenarios. Further, as depicted in FIG. 2, in an embodiment, the database 210 is split into two schemas: schema for system A 211 and schema for system B 212. In another embodiment, the number of sources systems and, therefore, corresponding schemas in the database 210 can be greater than 2.

In an embodiment, once the meta-data from the source systems 230 and 240 is replicated, the application tables in the database 210 including the meta-data are consumed via consumption nodes 213 and 214, respectively, in order to automatically generate local CDS views 221 and 222 on top of the application database tables. Further, after the local CDS views 221 and 222 are generated, data other than meta-data from source systems 230 and 240 is replicated in order to populate the application tables in database 210. Further, any new changes (e.g., releases, updates or enhancements) to the CDS views at the respective source systems are automatically replicated at the central server 220 as they occur.

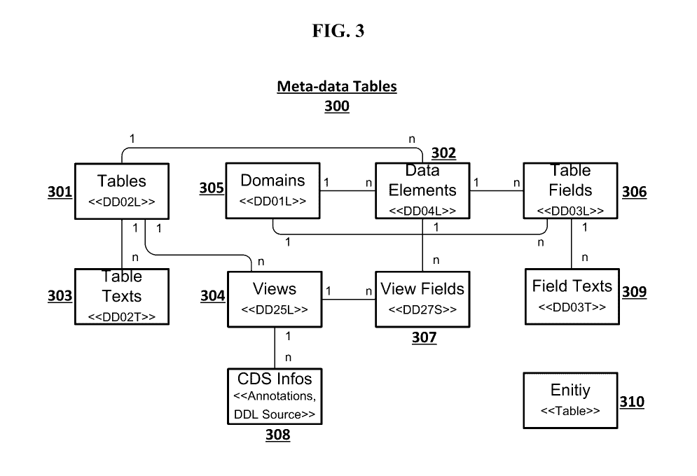

FIG. 3 illustrates an embodiment of Data Dictionary tables containing the meta-data. In an embodiment, meta-data tables 300 of FIG. 3 include the relevant meta-data for the CDS views. In an embodiment, meta-data tables 300 include tables 301, data elements 302, table texts 303, views 304, domains 305, table fields 306, view fields 307, CDS information 308 (e.g., annotations, DDL sources), field text 309 and entity 310. Further, FIG. 3 also depicts how each of the tables is related to the other tables (e.g., through a key-based relationship). In an embodiment, the meta-data of source systems 230 and 240 in FIG. 2 corresponds to the structure of the Data Dictionary tables in FIG. 3. In an embodiment, if the meta-data of a source system does not correspond to the structure of the Data Dictionary tables in FIG. 3, the meta-data of that source system is mapped to a set of tables corresponding to the structure of the Data Dictionary tables in FIG. 3. In an embodiment, the mapping is performed before the meta-data is replicated at the database (e.g., 210).

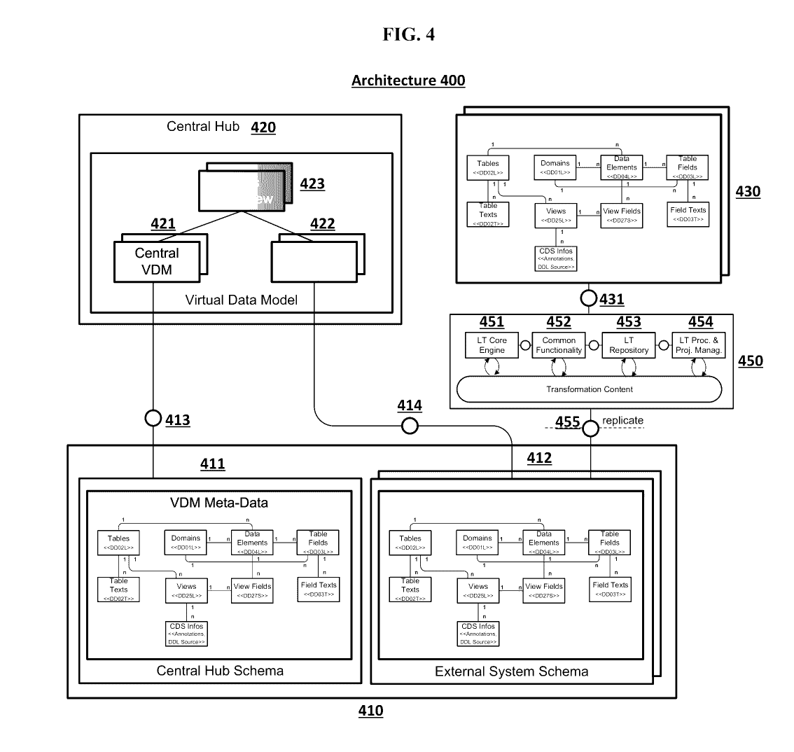

FIG. 4 illustrates another embodiment of the architecture utilized in the present disclosure. In an embodiment, architecture 400 of FIG. 4 includes a database 410, a central server 420 (“central hub”), source systems 430, extracting node 431, data extractor 450, replicating node 455 and consumption nodes 413 (i.e., corresponding to the central hub schema of database 410) and 414 (i.e., corresponding to the external system schema of database 410). In an embodiment, database 410 is an in-memory database system. In an embodiment, the central hub 420 includes central CDS views 421 (i.e., corresponding to CDS views associated with the central hub 420), local CDS views 422 (i.e., corresponding to CDS views associated data originating from an external system) and cross CDS views 423. In an embodiment, data extractor 450 is utilized for transactional replication. In an embodiment, data extractor 450 (e.g., SAP® Landscape Transformation or “SLT”) tracks database changes and copies data/meta-data accordingly. In an embodiment, the initialization of data replication is based on database triggers and a “delta-logging” concept. This allows real-time or scheduled data replication of the tables that are chosen. The data replication solution provides a flexible and reliable replication process including near zero downtime or test data migration. Data extractor 450 includes an LT core engine 451, common functionality 452, LT repository 453 and LT project & process management 454. In an embodiment, LT core engine 451 is utilized for conversion, migration and replication; common functionality 452 provides capabilities like configuration, simulation and security; LT Repository 453 is utilized for content development in terms of transformation or replication logic; and LT project & process management 454 enables (i) the organization of replication projects, (ii) monitoring of replication processes and (iii) trouble shooting. Accordingly, with data extractor 450, the meta-data tables corresponding to the external source system 430 can be extracted (via extracting node 431) and replicated (via replicating node 455) in database 410 (and therefore, the central hub 420). Further, this meta-data replication reflects all the release or extension specifics of the CDS views for source system 430. In an embodiment, after the meta-data is replicated into the central hub 420, the master and transactional data is also replicated into the central hub 420. Accordingly, the cross CDS views 423 can be defined over the central CDS views 421 and the local CDS views 422. In an embodiment, the cross CDS views 423 are stored in the central hub schema 411 of the database 410. In an embodiment, global entities are also stored in the central hub schema 411 of the database 410. For example, assuming a global CDS view for sales orders, local sales orders must be mapped to the central hub schema 411 of database 410 in order to provide a consolidated view for reporting.

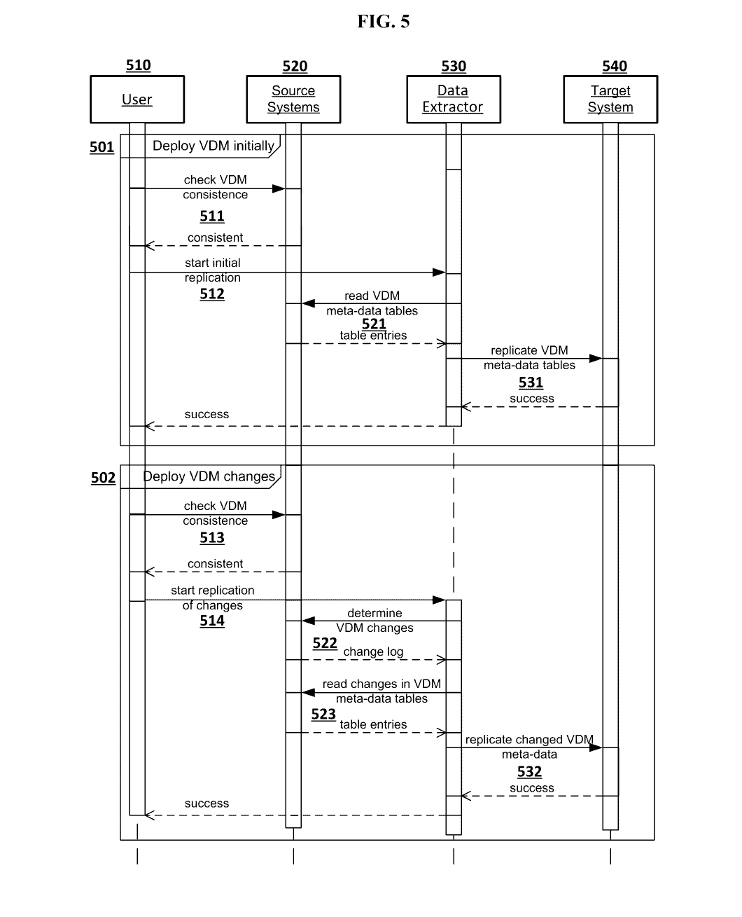

FIG. 5 illustrates an embodiment of the interaction between the elements of the architecture utilized in the present disclosure. In an embodiment, FIG. 5 displays two replication scenarios, (i) 501 (i.e., initial deployment of meta-data from sources systems 520) and 502 (i.e., replication of any changes or updates made to the meta-data from the source systems 520). With regard to scenario 501 (i.e., initial deployment), in step 511, the VDM at the source systems 520 is checked for consistency. For example, inconsistencies can occur if a column in an application table is deleted but CDS views referring to this field are not adjusted, which could potentially result in corruption of data during the cross-system analytics. In an embodiment, consistency checks are automatically performed by the source systems upon determining that either scenario 501 or 502 was initiated. Once it is determined that the VDM is consistent, replication can commence, as depicted in step 512. Accordingly, in step 521, data extractor 530 (i) reads the relevant VDM meta-data tables from the source systems 520 and (ii) extracts the relevant VDM meta-data tables from the source systems 520. Then, in step 531, the data extractor 530 replicates the relevant VDM meta-data tables from the source systems 520 into the target system 540 (e.g., central hub).

With regard to scenario 502, in step 513, the VDM at the source systems 520 is checked for consistency. Once it is determined that the VDM is consistent, replication can commence, as depicted in step 514. Accordingly, in step 522, data extractor 530 determines if there were any changes made to the VDM by parsing the change log at the source systems 520. In an embodiment, the change log keeps track of all changes to the VDM at source systems 520. Therefore, in step 523, data extractor 530 (i) reads the relevant changes in the VDM meta-data tables from the source systems 520 and (ii) extracts the relevant changes in VDM meta-data tables from the source systems 520. Then, in step 532, the data extractor 530 replicates the relevant changes in the VDM meta-data tables from the source systems 520 into the target system 540 (e.g., central hub).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Although the foregoing disclosure has been described in some detail for purposes of clarity of understanding, it will be apparent that certain changes and modifications can be practiced within the scope of the appended claims. The described embodiment features can be used with and without each other to provide additional embodiments of the present disclosure. The present disclosure can be practiced according to the claims without some or all of these specific details. For the purpose of clarity, technical material that is known in the technical fields related to the disclosure has not been described in detail so that the present disclosure is not unnecessarily obscured. It should be noted that there are many alternative ways of implementing both the process and apparatus of the present disclosure. Accordingly, the present embodiments are to be considered as illustrative and not restrictive, and the disclosure is not to be limited to the details given herein, but can be modified within the scope and equivalents of the appended claims.

What is claimed is:

1. A computer-implemented method for deploying core data service views from different source systems to a central server, the method comprising:
extracting, with a data extractor, meta-data corresponding to a core data service view from at least one source system, replicating, with the data extractor, the meta-data into the central server;
generating, with the central server, the core data service view based on the meta-data; and
upon determining a change to the meta-data at the at least one source system, updating, with the central server, the core data service view at the central server based on the change to the meta-data at the at least one source system.

2. The method of claim 1, further comprising:
parsing, with the data extractor, a change log at the least one source system;
extracting, with the data extractor, the changes to the meta-data at the at least one source system; and
replicating, with the data extractor, the changes to the meta-data into the central server.

3. The method of claim 1, further comprising:
upon generating the core data service view at the central server, replicating, with the data extractor, master and transactional data from the at least one source system into the central server.

4. The method of claim 1, wherein the meta-data corresponds to data dictionary tables stored in the at least one source system.

5. The method of claim 1, wherein each source system of the at least one source system corresponds to a same virtual data model.

6. The method of claim 1, wherein the at least one source system corresponds to a virtual data model different from a virtual data model associated with the central server.

7. The method of claim 6, further comprising:
mapping, with a processor, meta-data associated with the different virtual data model to tables corresponding to the virtual data model associated with the central server.

8. A non-transitory computer readable medium containing program instructions for deploying core data service views from different source systems to a central server, wherein execution of the program instructions by one or more processors of a computer system causes one or more processors to carry out the steps of:
extract, with a data extractor, meta-data corresponding to a core data service view from at least one source system, replicate, with the data extractor, the meta-data into the central server;
generate, with the central server, the core data service view based on the meta-data; and
upon determining a change to the meta-data at the at least one source system, update, with the central server, the core data service view at the central server based on the change to the meta-data at the at least one source system.

9. The non-transitory computer readable medium of claim 8, further comprising:
parse, with the data extractor, a change log at the least one source system;
extract, with the data extractor, the changes to the meta-data at the at least one source system; and
replicate, with the data extractor, the changes to the meta-data into the central server.

10. The non-transitory computer readable medium of claim 8, further comprising:
upon generating the core data service view at the central server, replicate, with the data extractor, master and transactional data from the at least one source system into the central server.

11. The non-transitory computer readable medium of claim 8, wherein the meta-data corresponds to data dictionary tables stored in the at least one source system.

12. The non-transitory computer readable medium of claim 8, wherein each source system of the at least one source system corresponds to a same virtual data model.

13. The non-transitory computer readable medium of claim 8, wherein the at least one source system corresponds to a virtual data model different from a virtual data model associated with the central server.

14. The non-transitory computer readable medium of claim 13, further comprising:
map, with a processor, meta-data associated with the different virtual data model to tables corresponding to the virtual data model associated with the central server.

15. A system directed to deploying core data service views from different source systems to a central server, comprising of:
at least one source system, wherein the at least source system includes meta-data corresponding to a core data service view from the at least one source system;
a data extractor;
a central server;
a processor, wherein the processor is configured to perform the steps of:
extracting, with the data extractor, the meta-data from the at least one source system,
replicating, with the data extractor, the meta-data into the central server;
generating, with the central server, the core data service view based on the meta-data; and
upon determining a change to the meta-data at the at least one source system, updating, with the central server, the core data service view at the central server based on the change to the meta-data at the at least one source system.

16. The system of claim 15, wherein the processor is configured to further perform the steps of:
parsing, with the data extractor, a change log at the least one source system;
extracting, with the data extractor, the changes to the meta-data at the at least one source system; and
replicating, with the data extractor, the changes to the meta-data into the central server.

17. The system of claim 15, wherein the processor is configured to further perform the steps of:
upon generating the core data service view at the central server, replicating, with the data extractor, master and transactional data from the at least one source system into the central server.

18. The system of claim 15, wherein the meta-data corresponds to data dictionary tables stored in the at least one source system.

19. The system of claim 15, wherein the at least one source system corresponds to a virtual data model different from a virtual data model associated with the central server.

20. The system of claim 19, wherein the processor is configured to further perform the steps of:
mapping, with the processor, meta-data associated with the different virtual data model to tables corresponding to the virtual data model associated with the central server.
